(19) United States
(12) Patent Application Publication
(10) Pub. No.: US 2025/0103305 A1
(43) Pub. Date: Mar. 27, 2025

(54) ITERATIVE POLICY-GUIDED PROGRAM SYNTHESIS

(71) Applicant: QUALCOMM Technologies, Inc., San Diego, CA (US)

(72) Inventors: Natasha BUTT, Amsterdam (NL); Auke Joris WIGGERS, Amsterdam (NL); Corrado RAINONE, Haarlem (NL); Blazej Jakub Manczak, Amsterdam (NL); Taco Sebastiaan Cohen, Amsterdam (NL)

(21) Appl. No.: 18/538,895

(22) Filed: Dec. 13, 2023

Related U.S. Application Data
(60) Provisional application No. 63/585,734, filed on Sep. 27, 2023.

(51) Int. Cl. G06F 8/35

(52) U.S. Cl. CPC G06F 8/35

(57) ABSTRACT

Systems and techniques are described for providing iterative policy-guided program synthesis. For example, a device may generate, based on a policy that receives input-output data of one or more tasks as input, a first set of programs, add the first set of programs and the input-output data to the training dataset to generate an updated training dataset, train the policy based on the first set of programs and the input-output data to generate an updated policy, identify, based on the updated policy, a second set of programs for second input-output data for a second set of tasks, add the second set of programs and second input-output data to the updated training dataset to generate a second updated training dataset; and train the updated policy based on the second set of programs and the second input-output data to generate a second updated policy.

### CROSS-REFERENCE TO RELATED APPLICATIONS

This application claims the benefit of U.S. Provisional Application No. 63/585,734, filed Sep. 27, 2023, which is hereby incorporated by reference, in its entirety and for all purposes.

### TECHNICAL FIELD

The present disclosure generally relates to program synthesis. For example, aspects of the present disclosure relate to an iterative process of applying a search or sample stage and a generalization or learning stage (e.g., utilizing a training process) to update a machine learning model (e.g., a large language model). Systems and techniques are described herein that can automatically generate new training data that is correctly annotated without human intervention and thus more scalable for model training.

### BACKGROUND

Large language models (LLMs) have shown extraordinary capabilities on a wide range of tasks. Recent work demonstrates that giving an LLM access to tools, such as calculators, notepads, or code interpreters, can substantially improve performance of the LLM. Additionally, using the class of models in policy improvement algorithms has proven effective when solving specific problems, such as finding fast sorting algorithms or machine translation.

LLMs pretrained on large datasets can generalize to a wide range of tasks when prompted appropriately. Instruction finetuning and reinforcement from human feedback (RLHF) enables generalization with less prompt engineering by aligning the generated output with human expectations. Acquiring the training data for such training can be expensive when human feedback is necessary. In addition, data used for the training can be noisy if the LLM is used to generate the feedback. Furthermore, when the LLM is not able to solve a task, both instruction finetuning and RLHF may not enable the LLM to solve the task.

### SUMMARY

The disclosed technology addresses the issues raised above by extending a pretrained language model (e.g., an LLM) beyond its initial capabilities. For example, systems and techniques described herein solve challenging reasoning problems using different datasets, such as the Abstract Reasoning Corpus (ARC) dataset. A goal of the ARC dataset is to measure intelligence as skill-acquisition efficiency over a range of different tasks or problems. Due to the limited size of the training dataset and the difficulty of each individual task/problem, generalization between tasks is a major challenge. The disclosed systems and techniques can be used to automatically generate new training data that is correctly annotated without human intervention. Such a solution can make an LLM more scalable relative to alternatives that would require more human intervention.

In some aspects, the techniques described herein relate to an apparatus to generate a program in an iterative process, including: at least one memory; and at least one processor coupled to the at least one memory and configured to: generate, based on a policy that receives input-output data of one or more tasks as input, a first set of programs; add the first set of programs and the input-output data to a training dataset to generate an updated training dataset; train the policy based on the first set of programs and the input-output data to generate an updated policy; identify, based on the updated policy, a second set of programs for second input-output data for a second set of tasks; add the second set of programs and second input-output data to the updated training dataset to generate a second updated training dataset; and train the updated policy based on the second set of programs and the second input-output data to generate a second updated policy.

In some aspects, the techniques described herein relate to a method of generating a program in an iterative process, the method including: generating, based on a policy that receives input-output data of one or more tasks as inputs, a first set of programs; adding the first set of programs and the input-output data to a training dataset to generate an updated training dataset; training the policy based on the first set of programs and the input-output data to generate an updated policy; identifying a second set of programs for second input-output data for a second set of tasks and based on the updated policy; adding the second set of programs and second input-output data to the updated training dataset to generate a second updated training dataset; and training the updated policy based on the second set of programs and the second input-output data to generate a second updated policy.

In some aspects, the techniques described herein relate to an apparatus for generating a program in an iterative process, the apparatus including: means for generating, based on a policy that receives input-output data of one or more tasks as inputs, a first set of programs; means for adding the first set of programs and the input-output data to a training dataset to generate an updated training dataset; means for training the policy based on the first set of programs and the input-output data to generate an updated policy; means for identifying a second set of programs for second input-output data for a second set of tasks and based on the updated policy; means for adding the second set of programs and second input-output data to the updated training dataset to generate a second updated training dataset; and means for training the updated policy based on the second set of programs and the second input-output data to generate a second updated policy.

In some aspects, the techniques described herein relate to a computer-readable storage medium storing instructions which, when executed by at least one processor, cause the at least one processor to be configured to: generate, based on a policy that receives input-output data of one or more tasks as input, a first set of programs; add the first set of programs and the input-output data to the training dataset to generate an updated training dataset; train the policy based on the first set of programs and the input-output data to generate an updated policy; identify, based on the updated policy, a second set of programs for second input-output data for a second set of tasks; add the second set of programs and second input-output data to the updated training dataset to generate a second updated training dataset; and train the updated policy based on the second set of programs and the second input-output data to generate a second updated policy.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device or wireless communication device (e.g., a mobile telephone or other mobile device), a wearable device (e.g., a network-connected watch or other wearable device), a robot or other agent asked to perform a task, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyroscopes or gyrometers, one or more accelerometers, any combination thereof, and/or other sensor. Generally, this disclosure relates to training robots in new ways to perform tasks as described, and the robot can be part of any XR, VR, AR or MR device or system. For example, a robot might be configured in a virtual reality environment, in which the virtual reality images can represent the frames used as input described herein as part of the use of the large vision model.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a conceptual diagram illustrating a how to solve abstract reasoning tasks, in accordance with some aspects of this disclosure;

FIG. 2 is a block diagram illustrating an expert iterative policy-guided search and learning process with language models, in accordance with some aspects of this disclosure;

FIG. 3A is a set of graphs showing results of applying the principles disclosed herein, in accordance with some aspects of this disclosure;

FIG. 3B is a graph showing grid size versus token count for training data, in accordance with some aspects of this disclosure;

FIG. 4 is a block diagram illustrating an approach for using intermediate states for an iterative policy-guided search and learning process with language models, in accordance with some aspects of this disclosure;

FIG. 5A is a block diagram illustrating a first extended method using execution trace, in accordance with some aspects of this disclosure;

FIG. 5B is a block diagram illustrating a second extended method using execution trace and environmental forcing, in accordance with some aspects of this disclosure;

FIG. 6 is a flowchart illustrating an example process for using an iterative process via a policy-guided search stage with a learning stage, in accordance with some aspects of this disclosure;

FIG. 7 is a block diagram illustrating an example of a deep learning network, in accordance with some aspects of this disclosures; and

FIG. 8 is a diagram illustrating an example system architecture for implementing certain aspects described herein, in accordance with some aspects of this disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As noted above, LLMs have extraordinary capabilities on a wide range of tasks. For example, when LLMs are pretrained on huge datasets, they have a strong ability in generalizing to a wide range of tasks when prompted appropriately. An LLM can include a transformer-based neural network. One example of a goal of an LLM model is to predict text that is likely to come next in a series of text. The sophistication and performance of a model can be judged by how many parameters the model has. A model's parameters are the number of factors the model considers when generating output. LLM examples can include open-source language models that are deployable on-premise or in a private cloud. Some example LLMs include, BLOOM, NeMO LLM, XLM-ROBERTa, XLNet, Cohere and GLM-130B.

Use cases for LLMs include applications in many different industries, such as healthcare, retail, technology, and more. Use cases that exist in various industries can include text summarization, text generation, sentiment analysis, content creation, chatbots, virtual assistants, and conversational artificial intelligence, named entity recognition, speech recognition and synthesis, image annotation, text-to-speech synthesis, spell correction, machine translation, recommendation systems, fraud detection, accomplishing tasks and code generation.

LLMs can be trained by deep learning neural networks, a subset of artificial intelligence and machine learning. For example, LLMs may first be pre-trained so that they learn basic language tasks and functions. Pretraining is a step that requires massive computational power and cutting-edge hardware. Once the model is pre-trained, the model can be trained with task-specific new data to fine-tune the model for specific use cases. The fine-tuning method has high computational efficiency since the model requires less data and power, making the method cheaper to implement.

Systems, apparatuses, processes (also referred to as methods), and computer-readable media (collectively referred to as “systems and techniques”) are described herein that can extend a pretrained language model (e.g., an LLM) beyond initial capabilities of the pretrained model. For example, the systems and techniques can solve challenging reasoning problems using different datasets, such as the Abstract Reasoning Corpus (ARC) dataset. An aim of the ARC dataset is to measure intelligence as skill-acquisition efficiency over a range of different tasks. Due to the limited size of the training dataset and the difficulty of each individual problem, generalization between tasks is a major challenge.

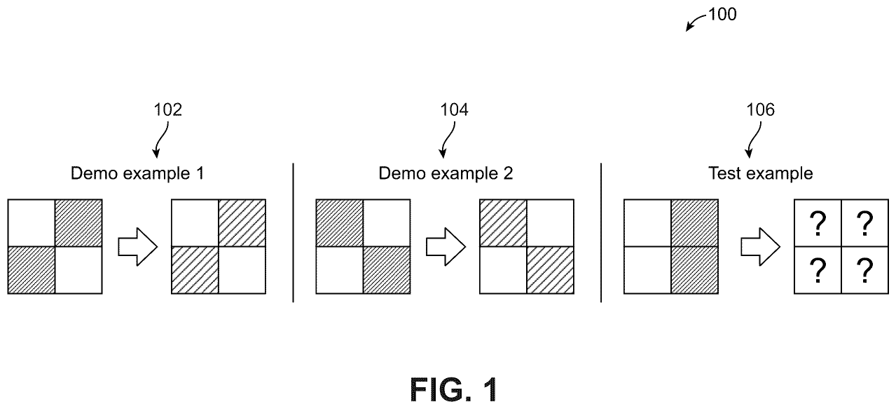

A dataset of tasks can be used when working with the ARC dataset (or other dataset). In some cases, the tasks in the dataset of tasks can include grid-like input-output pairs. For instance, one or more input-output pair(s) can be given as context, and one or more new inputs are provided. A goal is to predict corresponding output(s) for the new inputs by inferring, from context, the program that resulted in an example input turning into an example output. Sample tasks are shown in FIG. 1. In the first demonstration example input grid 102, the task is to change the shading or color of each square in the first grid to a particular shading for each square in the second grid. Other tasks can be contemplated. For example, the program or task may be to crop a set of black squares in a grid around an object in the grid that is identified by one or more colored squares in a tight-fitting rectangular bounding box.

In another example task, the program may “pull” a plurality of distributed grey squares in a grid (say a 8×8 grid) to a red object in the grid using straight or diagonal lines. Most humans are able to imagine separate objects interacting with each other, for example predicting what would happen if the red square started to exert a gravitational force on the grey squares, or imagining that the grey squares are objects flying towards the red square. Capturing such an interaction in a program, however, may be more challenging.

The number of input-output pairs may differ per task. In some cases, it is possible that seeing just one example is sufficient to determine the desired outcome. In some cases, however, the pattern only becomes apparent when considering all pairs.

The systems and techniques described herein provide an iterative program synthesis approach. The systems and techniques provide an intra-task generalization capability on one or more datasets, such as the ARC dataset. A goal for each ARC task can be to write a program that, when applied on an input grid, produces the correct output grid. According to some aspects, by writing the program that performs the desired task, the systems and techniques can generate new training data that is correctly annotated without human intervention.

In some aspects, the systems and techniques can alternate between a sample or search stage and a generalization or learning stage. In the search stage, a system can sample new programs conditioned on the input-output examples from a training dataset. The system can then correct the output by replacing the original output with the actual output produced by the program and adds the program together with the input-output examples to the training dataset to generate an updated training dataset. In the generalization or learning stage, the system trains the language model on the generated or updated training dataset. The updated model (or updated “policy” as that term is used herein) is then used during the sampling or searching stage of the next iteration. By applying such a process, the system can automatically generate the new training data. Further, the new training data can be correctly annotated without any human intervention. Typically, requiring human intervention increases the cost and time to annotate training data. The disclosed approach is thus more scalable.

The policy can take the task demonstration examples, S₀, S_{N}*, as input and output lines of code that apply functions to variables in the memory resulting in new variables, or otherwise define a new variable followed by a value of or associated with the variable such as (A₀, ΔS₁, A₁, ΔS₂, . . . , A_{N-1}, ΔS_{N}).

Various aspects of the present disclosure will be described with respect to the figures. Illustrative aspects are also provided in Appendix A provided herewith.

FIG. 1 illustrates an example conceptual diagram of how to solve for abstract reasoning tasks 100. In a first demonstration example input grid 102, squares of a certain color or shading are processed by the program to generate a new colored or shaded square in a grid. The block or square-based approach illustrates the concept of using a small grid size for the task and how a first demonstration example input grid 102 and a second demonstration example input grid 104 can be provided to the model. Solutions are generalized from the first demonstration example input grid 102 and the second demonstration example input grid 104 to a test example grid 106 that has not been specifically seen before. Tasks vary in number of demonstration examples, number of test examples, and grid sizes. To “solve” an ARC task, a system can, for example, execute three programs on the test example and one of the three should output all the test outputs when evaluated on all the test inputs.

The iterative approach provided by the systems and techniques disclosed herein uses a policy which can be a large language model (LLM) or some other machine learning model. Iterative policy improvement procedures have been applied to many problems, including game-playing, combinatorial problems, question-answering, program synthesis, among others. Expert iteration is one such class of approaches, including a policy-guided planning stage and a generalization stage where the policy is updated. The policy-guided planning stage relates to a search stage and the generalization stage relates to the learning stage discussed below.

Reinforced self-training has been shown to confirm that policy improvement is also possible without a strong search-based expert. A challenge with iterative procedures is to ensure that the search stage and the learning stage are working together towards continual policy (model) improvement. For example, if the policy overfits, then the search stage in the next meta-iteration may produce less varied useful experiences, potentially leading to a negative feedback loop. Common techniques that prevent stagnation include adding noise to policy output to force exploration, inserting artificial data into the experience buffer, or filtering experiences before training. Any of these techniques or approaches may be included as part of the process disclosed herein.

In some cases, the systems and techniques described herein can use a strong search-based expert. However, the downside of such an approach is complexity of implementation, which may require careful design to ensure search is efficient. In some aspects, the systems and techniques can thus use straightforward sampling approaches and can benefit from advances in LLM sampling.

The field of program synthesis is concerned with generating programs that solve specific problems. Reinforcement learning and language models (e.g., LLMs) can be applied to such problems. Variations include execution-guided program synthesis, where a policy (e.g., an LLM) has access to an interpreter to evaluate intermediate programs, and approaches that construct programs step-by-step with feedback at each step. When using an intermediate program or state (e.g., where a program has multiple different states because the program has more than one or two lines of code), some techniques may stop at an intermediate state of the program and then train a policy (e.g., LLM) conditioned on that intermediate state.

As noted previously, the systems and techniques described herein may use the Abstract Reasoning Corpus (ARC), which is a dataset designed to benchmark “fluid intelligence”, including 400 training tasks and 400 evaluation tasks. Each task is a problem that forces an agent (human or artificial) to reason about the connection between shown input-output pairs. The agent is first shown one or more demonstration examples, each including an input grid and an output grid. Then, given one or more test input grids, the agent should specify the corresponding output grid(s) in three trials or fewer. FIG. 1 discussed above provides a visualization of an artificial example. The dataset was designed to be challenging for learning-based approaches. There are few datapoints available and finding the solution means reasoning about the relation between multiple demonstration examples, and grid sizes may vary. I one aspect, the problem is an open-DSL (domain-specific languages) problem, meaning that one is free to define the search-space using custom domain-specific languages.

The disclosed systems and techniques can perform program synthesis for the ARC dataset. Each ARC task is considered as a program synthesis problem, and the disclosed systems and techniques aims to find a program that, when run on the test input, produces the correct output. This disclosure defines “demonstration performance” as the percentage of demonstration examples for the task that is solved by the program, and “test performance” as the percentage of test examples solved by the program. The search stage implemented by a search engine (discussed in more detail below) can search for programs that achieve maximum demonstration performance, as the search procedure can lead to improved test performance.

In some aspects, the systems and techniques restrict the program to a programming language associated with the domain-specific language (DSL), which may be designed specifically for the ARC data. The DSL can contain basic grid manipulation operators. For example, the DSL may include a vertical mirror (vmirror) function or operator that can manipulate a grid by mirroring the grid along a vertical axis. The DSL may additionally or alternatively include a horizontal mirror (hmirror) function that mirrors a grid along horizontal axis.

In some aspects, the systems and techniques pose as few restrictions as possible on the policy. In some examples, the systems and techniques can use an open-source encoder-decoder model (the CodeT5 model). Instead of encoding the grid using integer arrays, the systems and techniques can exploit the fact that most grids contain repeated patterns and are therefore compressible. In some cases, the systems and techniques can choose, for a text representation of the grid, input that works well for sparse grids and is human-interpretable. For example, the first demonstration example input grid 102 from FIG. 1 could be represented as follows:
grid 3×4 bg=red grey=[[0, 2], [1, 1], [1, 2], [2, 1]].

The systems and techniques described herein are not limited to any particular grid encoding strategy. For example, other approaches can be used, such as encoding input grids with vision models such as convolutional neural networks (CNNs).

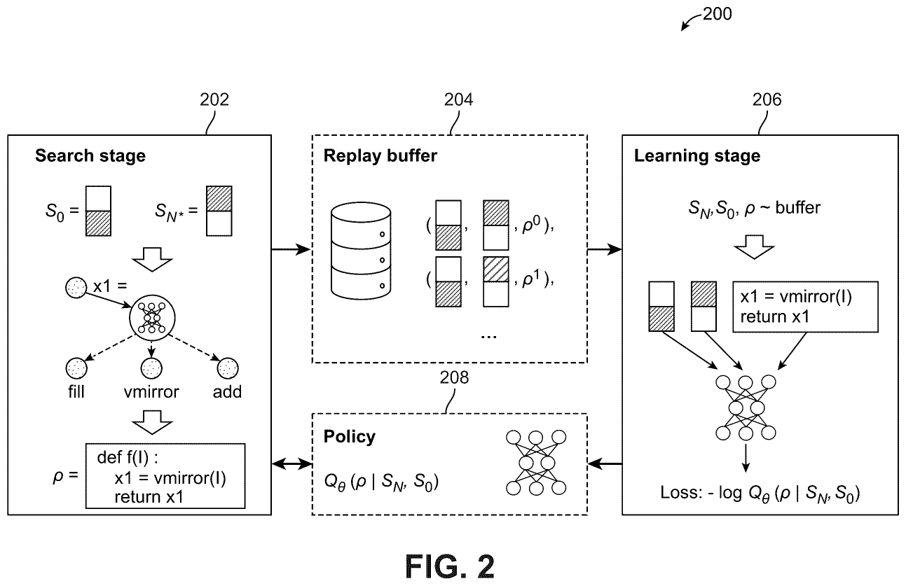

FIG. 2 illustrates a block diagram of a search and learning system 200 that can perform an expert iterative policy-guided search and learning process. The search and learning system 200 includes a number of different components. A search stage can be implemented by a search engine 202. A replay buffer 204 stores data such as input grids, output grids and programs, and in some cases other data. The replay buffer 204 can be initialized with training tasks and tasks found from mutating or altering some training tasks to prevent overfitting. A learning engine 206 implements a training or learning stage to process data received from the replay buffer 204. A policy 208 can represent a model that performs a tokenizing process. The policy 208 can be, for example, the known CodeT5 model and tokenizer. The policy 208 can be any machine learning model such as a neural network or a large language model (LLM). The different components are operated in an iterative, policy-guided search and learning process to generate a program that, when applied to an input grid, produces the correct output grid. Using a sparse grid representation (e.g., small grids with a small number of squares in the grid such as in FIG. 1) substantially reduces the number of tokens required to encode most grids compared to a plaintext representation. In some examples, a “small” grid can be a grid of 5×5 squares or less.

The population of the training data can be initialized with the training tasks, which can include example tasks and hand-designed programs that solve the tasks. In some cases, the population of training data can be initialized to be empty, which would mean training starts “from scratch.” A population tree can be also maintained which tracks the parents of each task and the mutation between a parent and its child. Tracked metrics may be useful later on as one may choose to filter the population to remove child tasks which have the same inputs and equivalent programs to their parents, for example, the addition of new variable definitions.

The policy 208 can be implemented as any model or tokenizer. One example model as described above is the CodeT5 model, tokenizer which is based on open-source tokenizers, text designed to match tokenizer. CodeT5+ identifies a family of open code LLMs trained with flexible model architecture and diverse learning objectives. Operating as encoder-only, decoder-only, or encoder-decoder models, CodeT5+ can be easily adapted to many downstream tasks, including both code understanding and generation tasks. In an alternative approach, the policy 208 can see multiple demonstration examples. In some aspects, the policy 208 can be a vision-language model parsing grids using convolutional encoders. In some cases, the policy 208 may be a decoder-only LLM.

As noted above, the search and learning system 200 can perform an iterative process (e.g., an expert iteration) through the components of the search and learning system 200. The iterative process can include two stages: a search stage and a training stage (also referred to as a learning stage). During the search stage, the search engine 202 can determine (e.g., find) new programs for given tasks using the policy 208 or based on the policy 208. The search engine 202 can add the new programs to the replay buffer 204. During the training stage or learning stage, the learning engine 206 can finetune the policy 208 on previously found programs from the replay buffer 204. Using the iterative process, the search and learning system 200 can generate new training data that is correctly annotated without human intervention.

In some aspects, the search engine 202, for each task in a given “search set” of tasks, can sample new programs using the policy 208. The search engine 202 can output one or more demonstration examples to the policy 208 and can decode a program. If the program is invalid (e.g., the program does not run correctly), the search and learning system 200 cannot use the program and continues to the next example. Otherwise, if a program is valid, the search engine 202 can run the program on each demonstration input S₀ to obtain a corresponding output S_{N}* and can evaluate whether the output is equal to the target output. The search engine 202 can then add a new entry to the replay buffer 204, including the demonstration inputs, the found outputs, the program, and the evaluation results. In some aspects, the search engine 202 does not add the test example nor performance on the test example to the replay buffer 204. In some cases, the search engine 202 can also mutate existing programs to artificially increase the dataset size. In some aspects, the search engine 202 can alter or change existing programs to create variations on the programs and can run the process to increase the dataset size. Using such an approach, new training data can be generated without the need for expensive and time-consuming human intervention.

As noted previously, in some aspects, the search engine 202 can mutate programs. Mutation of programs can occur in a number of different ways. In some cases, a mutation choice is sampled from mutating inputs or mutating programs. If the mutation choice is to mutate inputs, for each input in task demonstration examples and the test examples, the input grid is mutated by applying one grid transformation from the DSL. Grid transformations f_{grid}(args) can correspond to a primitive grid function and its arguments excluding arguments of a type grid. Primitive grid functions are primitive functions which output a grid. The system can sample a primitive grid function and then sample its arguments given the type of the function. The input grid is given to the grid function wherever there is an argument of the type grid.

If the mutation choice is to mutate a program, another mutation choice can be sampled from a replace function, replace argument, and add line. For the replace function, the system can randomly sample a function from the program and replace the function with a function of the same type. For replace argument, the system can randomly sample an argument from the program and replace the program with an argument of the same type. Finally, for add line, the system can randomly sample a position in the program and at the position the system can add a new variable definition by randomly sampling a function and its arguments. In some cases, there will be no immediate change to the programs functionality as the new variable is never referenced. A further mutation may be performed where the new variable is referenced in order to see a change in the semantics of the program.

In an alternative approach, the search engine 202 may use multiple demonstration examples which are fed to the policy 208 to decode the program.

In the training stage, the learning engine 206 optimizes a negative log-likelihood objective. Datapoints can be sampled by the learning engine 206 from the replay buffer 204 at random. In another aspect, other criteria could be used by the learning engine 206 to sample datapoints from the replay buffer 204. The learning engine 206 can pad each training input in a batch up to a maximum token length of 512. In other aspects, variations on the operations of the learning engine 206 can include applying transformer-specific training details, adjusting the batch size and masking a loss for the input grids.

In another aspect, one or more operations can be prioritized depending on whether a task to achieve is an artificial task or real task. For example, a real task may be assigned a higher priority than an artificial task.

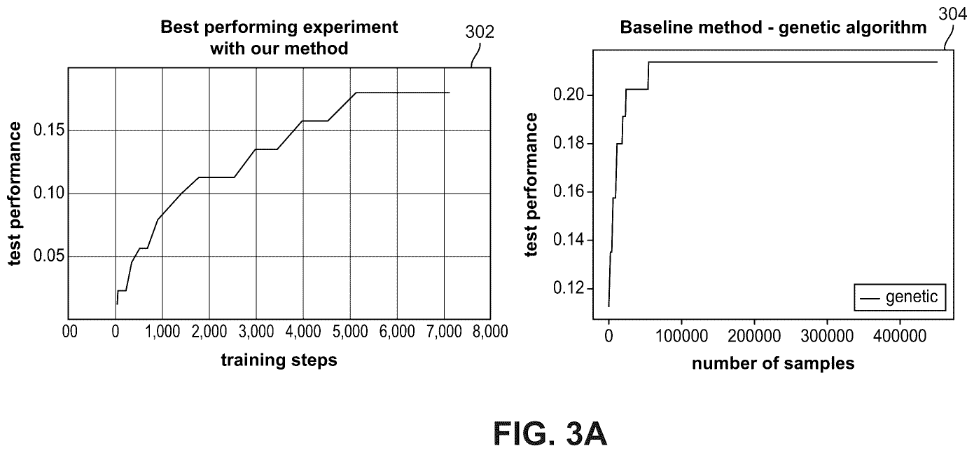

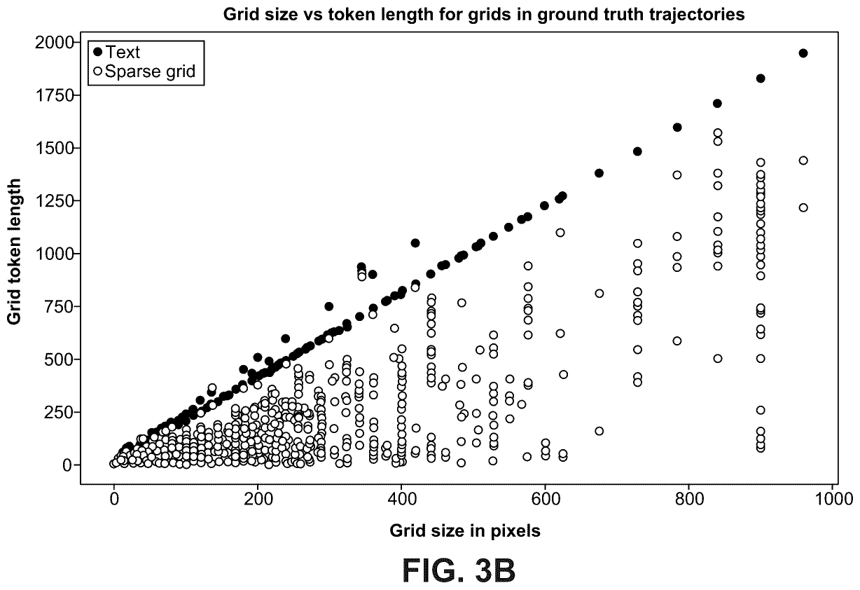

FIG. 3A is a set of graphs 302 and 304 showing results of applying the principles disclosed herein, in accordance with some aspects of this disclosure. Graph 302 illustrates results on a validation set for the search and learning system 200. The x-axis shows the training steps and the y-axis shows the test performance. The performance using the principles disclosed herein can reach a maximum of just over 5000 training steps. Graph 304 illustrates a number of samples on the x-axis and the test performance on the y-axis showing a baseline method with a mutation algorithm and how the test performance peaks at under 100,000 samples.

FIG. 3B is a graph showing grid size versus token count for ARC training data 210, in accordance with some aspects of this disclosure. The graph illustrates how the sparse grid representation (e.g., shown in FIG. 1) can substantially reduce the number of tokens required to encode most grids compared to a plaintext representation.

The expert iteration procedure performed by the search and learning system 200 can run on a “search set” and see the corresponding demonstration examples. To prevent cheating, the search and learning system 200 can use a custom validation split as the search set when selecting hyperparameters, instead of, for example, using the ARC evaluation set. For internal experiments and hyperparameter selection, the search and learning system 200 can take the ARC training set and split the training set into a custom train split Dₜᵣₐᵢₙ and validation split D_{validation}. One can choose the split such that Dₜᵣₐᵢₙ and D_{validation}. contain roughly equally difficult programs by sampling based on program length: Dₜᵣₐᵢₙ contains 80% of 2-line programs, 80% of 3-line programs, and so on. These choices result in 311 examples in Dₜᵣₐᵢₙ and 89 examples in D_{validation}.

In some cases, the search and learning system 200 can have the replay buffer 204 initialized with the examples in Dₜᵣₐᵢₙ, and provided with a target program. The search and learning system 200 can start the expert iteration procedure using the 89 validation examples as the search set. In some aspects, for a final experiment, one can initialize the replay buffer 204 with 400 ARC training tasks and perform expert iteration on the 400 ARC evaluation tasks.

In an evaluation phase, an example input-output pair can be deemed to be solved by a program if the program produces the desired output grid given the input grid (e.g., see FIG. 1). One can define “demonstration performance” as the percentage of solved demonstration examples for a given task. One can define that a “test performance” is a “1” if the test example for a given task is solved, and “0” otherwise. The number of solved tasks is then the number of tasks for which test performance is equal to 1. Note that, by coincidence, a program can solve a test example even if the program does not solve all demonstration examples and vice versa.

In some aspects, baseline procedures can be used measure the effectiveness of the system. For example, the search and learning system 200 may mutate programs and relabel the resulting programs with hindsight relabeling. In the mutation operation, at each meta-iteration, the search engine 202 samples n_{g}=nₚ*nₜₐₛₖₛ programs by mutating the population of training tasks. The search and learning system 200 can then evaluate each program on each of the tasks. In other aspects, the search and learning system 200 may use learned baseline procedures.

Experiments can be performed on an internal validation set. For example, the search and learning system 200 can initialize the replay buffer 204 with the 311 Dₜᵣₐᵢₙ examples and the search set is the 89 Dᵥₐₗ examples. The aim of the experiment is to find optimal hyper-parameters for search and training. A list of hyperparameters and their meaning is shown in Table 1:

TABLE 1
Table of hyperparameters.

| Exit | | |
|---|---|---|
| Phase | Param | Description |
| Search | n [symbol] | no. program samples ρ per meta-iteration |
| | n [symbol] | no. programs sampled from policy per task per meta- |
| | | iteration |
| | n [symbol] | no. programs sampled from random sampler per task |
| | | per meta-iteration |
| | n [symbol] | no. programs sampled from genetic algorithm per |
| | | meta-iteration |
| | g [symbol] | temperature |
| | g [symbol] | top_k sampling |
| | g [symbol] | top_p sampling |
| | g [symbol] | length penalty |
| Train | n [symbol] | no. train steps per meta-iteration |
| | n [symbol] | no. training examples sampled from replay buffer per |
| | | meta-iteration |
| | q [symbol] | model initialised per meta-iteration |

[symbol]

indicates data missing or illegible when filed

As noted herein, an expert iteration approach is described herein, which can solve problems in the Abstract Reasoning Corpus (ARC) (as well as other datasets). The process includes multiple iterations of search and learning. During the search stage, the search engine 202 identifies programs that solve ARC tasks, with guidance from a policy 208 which can be one of a transformer-based policy network, a language model, a large language model and/or an encoder-decoder model. The policy 208 can also be a vision-language model that parses gids using convolutional encoders. During the training stage, the training engine or learning engine 206 learns a new policy from previously found programs. The feedback loop allows the search and learning system 200 to tackle complicated reasoning tasks in iterations, learning from previous mistakes and successes in every round. The disclosed approach obtains state-of-the-art performance on the public ARC data and demonstrates that transformer-based policies are able to generalize between tasks.

One aspect of this disclosure relates to using intermediate tokens or intermediate states. The search and learning system 200 can choose whether to mask a loss over intermediate states or not. The following discussion is applicable when the loss is masked over intermediate states. The use of intermediate states is optional and may or may not be implemented in various cases.

Some terms used herein relate to language models and the use of intermediate states. The terms can include grounding, scratchpads and environment forcing. Grounding refers to learning connections between tokens representing linguistics (e.g., characters, words, phrases and an external context e.g. objects in the real world. One way to measure grounding may be to define some grounding tests. One can test grounding by asking language models how to stack a set of varied objects, since it is very unlikely the question is present in the training data. To answer the question successfully, one aspect of this disclosure causes the model to learn some connection between the phrase instructing the model to stack the objects, the words representing the objects and the external context of how objects interact in the real world due to size and shape.

A scratchpad as used herein can refer to the intermediate tokens a language model may output before ‘answer’ tokens are generated, enabling intermediate memory and computation. Note that the definition does not inform on how these intermediate tokens are generated.

Environment forcing as used herein can refer to enabling a model to interact with an environment at inference time by outputting tokens corresponding to a call to an external tool (e.g., an interpreter tool 519 or calculator or code interpreter) and observing tokens corresponding to the return of the call.

Programming-by-examples requires synthesizers to map from a set of input-output examples to programs. The process presents a grounding challenge for neural models, which must learn to connect tokens representing symbols of a programming language alphabet to an external context, the internal memory state of a machine on which the code is executed. In some aspects, one can solve such a problem of a grounding challenge by training a transformer (e.g., the policy 208, 408, 508, 518) to output intermediate tokens (a scratchpad) between each line of code representing changes in the memory state. The solution can also include environment forcing (e.g., via the search engine 202) at inference time by executing each code line and providing the feedback during conditional generation (e.g., the transformer or policy 208 has access to an interpreter tool). The scratchpad enables the model (e.g., the search and learning system 200) to use, store and reference intermediate computations before committing code to the program. Further, the interpreter tool 519 enables the search and learning system 200 to provide feedback during inference such that the model can benefit from in-context-learning on the current memory state. The interpreter tool 519 can be a component that takes input A₀ (such as a line of code) and returns an output S₁, which can be fed to the search engine 512. Once the grounding challenge is overcome, programming-by-examples with transformers becomes a combinatorial optimization problem of learning the correct sequence of operators) in the DSL that map from the input to the output. The disclosed solution can be applied to the ARC dataset, a collection of input-output examples designed as a general artificial intelligence benchmark.

Having access to an interpreter tool 519 can occur during the search stage or the operations of the search engine 202. The model can generate up until one sees a token that represents a certain state (intermediate state) so the search engine 202 can make a call to the interpreter tool. The generation process stops and the search engine 202 can pass the token to the interpreter tool 519 which can generate feedback. A variable associated with the process can be scalar or an integer. The search engine 202 can tokenize the variable and then just add the variable to the existing token so far. The search engine 202 can perform the process again and sample more tokens. The process can relate to the environment forcing disclosed more below.

An ARC task can be defined by a set of task demonstration examples {(Iᵢ, Oᵢ*) for i∈0, . . . , n_{d}} and test examples {(Iᵢ, Oᵢ*) for i∈0, . . . , nₜ}. The goal is to write a program p that outputs the test example outputs when executed on test example inputs (e.g., p (Iᵢ)=Oᵢ* for i∈0, . . . , nₜ). The ARC dataset includes 400 training task and 400 evaluation tasks. While the ARC dataset is used by way of example, other datasets and different numbers of training and evaluation tasks of course can be used. One known domain-specific language (DSL) for the ARC benchmark is generated by Michael Hodel which is a collection of primitive functions and constants written in python. The DSL syntax requires that each line of a program defines a new variable xⱼ apart from the final line which defines the new variable O. When defining a new variable, xⱼ, a function may be chosen from the primitive functions or previously defined variables x₀ . . . xⱼ₋₁. The arguments are then chosen from the primitive constants, primitive functions or the previously defined variables x₀ . . . xⱼ₋₁ of the correct type. Listing 1 illustrates the syntax of programs in the DSL.

Listing 1

def p(I):
x1 = f(args)
x2 = f(args)
...
O = f(args)
return O

The proposed method involves: (1) training a transformer to output intermediate tokens (a scratchpad) between each line of code representing partial changes in the memory state; (2) environment forcing at inference time by executing each code line and providing the feedback during conditional generation (e.g., the transformer has access to an interpreter tool); and (3) performing expert iteration at inference time by learning from generated programs and their execution results. With each iteration, the inventors expect that the policy generates programs that produce outputs closer to our target outputs.

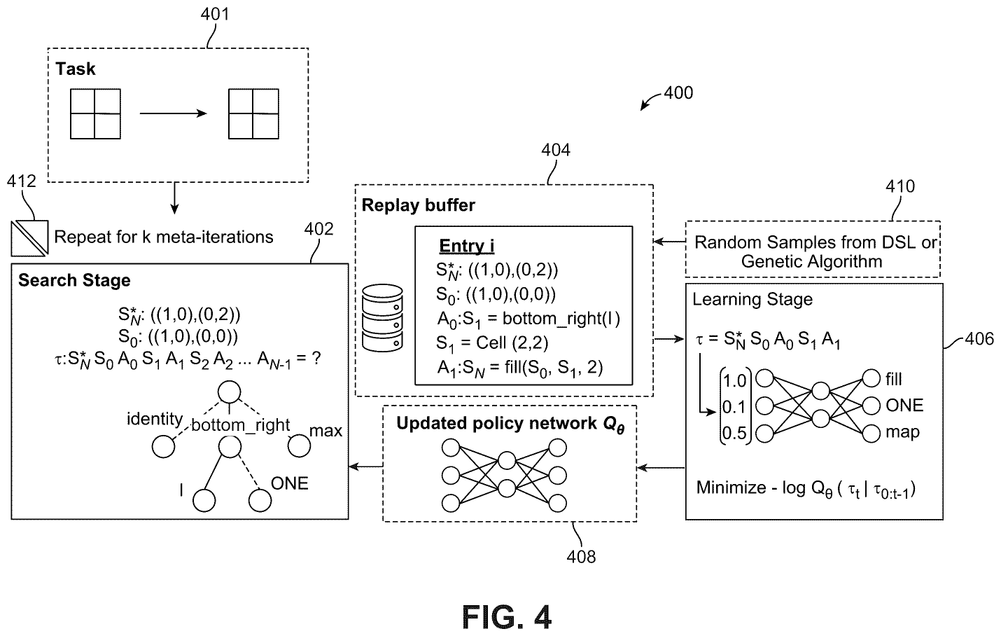

FIG. 4 illustrates an intermediate state search and learning system 400. Each component of the intermediate state search and learning system 400 will be referred to as an “intermediate state” component to differentiate the respective component from similar components shown in other figures. The intermediate state search and learning system 400 first pre-trains a policy (e.g., the intermediate state policy 408) on a set of training examples from the ARC training set. The intermediate state search and learning system 400 then begins expert iteration on the ARC evaluation set. The process involves iterating between a search stage operated by an intermediate state search engine 402 and a learning stage operated by an intermediate state learning engine 406. In the search stage, the intermediate state search engine 402 samples trajectories from the intermediate state policy 408 and applies filtering before adding the trajectories to an intermediate state replay buffer 404. The process can also include randomly sample trajectories from the DSL and/or running a mutation algorithm 410 and adding these also to the intermediate state replay buffer 404. In the learning stage, the intermediate state learning engine 406 trains on trajectories from the intermediate state replay buffer 404. Over time, one can expect that the samples will improve in quality, and that the intermediate state search and learning system 400 will be able to solve an increasing number of ARC evaluation tasks.

As noted above, a mutation algorithm can be used for data generation. One aim can be to grow the population of 400 training tasks to a size that is ‘learnable’ by a neural network and prevent neural network overfitting. A motivation to use a mutation algorithm is that the mutation algorithm enables the system to generate new programs that are close to successful programs according to some distance metric, as these programs are likely to work better than random programs. A distance metric can be quantified by operations in the DSL. The utility of the distance metric is based on two assumptions.

One assumption is that it is easier for the neural network to learn a general function from training tasks that are closer together in the program space as measured by the distance metric. Another assumption is that the evaluation tasks are likely to be close to the training tasks in the program space (as measured by the distance metric) and so are likely to fall in the domain of the learned function (interpolation).

The mutation algorithm evolves the training task population in the following way. First, the system selects a task from the population. Next, the task is mutated by either mutating the task inputs or mutating the program solution. The fitness of the mutated task is calculated with a fitness function. If the fitness score exceeds some threshold, the mutated task is added to the population.

In some aspects, a dataset can include 400 training tasks and solution programs. In the context of grids as shown in FIG. 1, there are input/output grids and then the program that maps from one to the other. The process can those programs and evolve them using the mutation algorithm. Some tasks can be solved within a few lines of code, whereas other tasks may take more code such as a hundred lines. Within the mutation algorithm, it is easier for the mutation algorithm to find one- or two-line programs, but then it can become more difficult as the programs get longer.

The above-described systems and techniques have various advantages. For example, the systems and techniques described herein can provide a neurosymbolic approach with a clear separation between the introduction of inductive bias and learning from large datasets. The inductive bias comes from priors around ‘objectness’ that are encoded in the primitives of the DSL and the sampling of the training programs. The intermediate state policy 408 may then learn from any number of sampled programs, under any sampling scheme.

There is also potential to shift to a more ‘learned’ approach by introducing an abstraction phase where new primitives are added to the DSL. Further, using expert iteration would also reduce dependence on the inductive biases introduced through the choice of sampling scheme. The mutation algorithm for augmenting the training dataset can be limited by a maximum program distance. As a result, for expert iteration, the intermediate state search and learning system 400 may even learn the distance measure such that the intermediate state search and learning system 400 receives a non-binary signal for program evaluation which may be used to rank ‘expert’ trajectories.

Another advantage of the systems and techniques described herein is that the approach provides a good test bed for the generalization powers of transformers, which is very relevant given the recent developments around conversational artificial intelligence and artificial general intelligence. The concepts are relevant because the ARC dataset is designed such that synthesizers have to learn a general representation of the task from task demonstration examples in order to solve the test examples. Furthermore, there is a baked-in incentive to produce short programs, as shorter programs are more likely to generalize across input-output examples. An optional addition is to make the incentive explicit, favoring shorter programs over longer ones during mutation and sampling. Moreover, in code generation frameworks where there is a DSL component and a search component, it may be difficult to compare approaches since there are two moving parts. In some aspects, the current benchmark uses the same DSL as is proposed herein and traditional search techniques, and so advances in performance can be attributed to the policy-guided search.

As noted above, FIG. 4 illustrates the intermediate state search and learning system 400 that includes the intermediate state search engine 402, the intermediate state replay buffer 404, the intermediate state learning engine 406 and the intermediate state policy 408. At a search stage, the intermediate state search engine 402 samples trajectories from the intermediate state policy 408 conditioned on a goal state (output grid) and the initial state (input grid). A task 401 is shown in FIG. 4 that is provided to the intermediate state search engine 402. The intermediate state search engine 402 adds the trajectories to the intermediate state replay buffer 404. However, the goal state is replaced with a terminal state of the sampled trajectory (e.g., the grid output) by executing the program A₀, A₁, A₂, . . . , A_{N-1} on the initial state S₀. The intermediate state learning engine 406 trains the intermediate state policy 408 to minimize the log likelihood of the trajectory conditioned on the terminal state and the initial state. The approach is iterative and can be repeated for k meta-iterations 412. In some aspects, the intermediate state learning engine 406 can receive random samples from the DSL or mutation algorithm 410 for its processing. In some cases, the sampling of DSL from the intermediate state replay buffer 404 can be non-random and based on any number of factors or protocols.

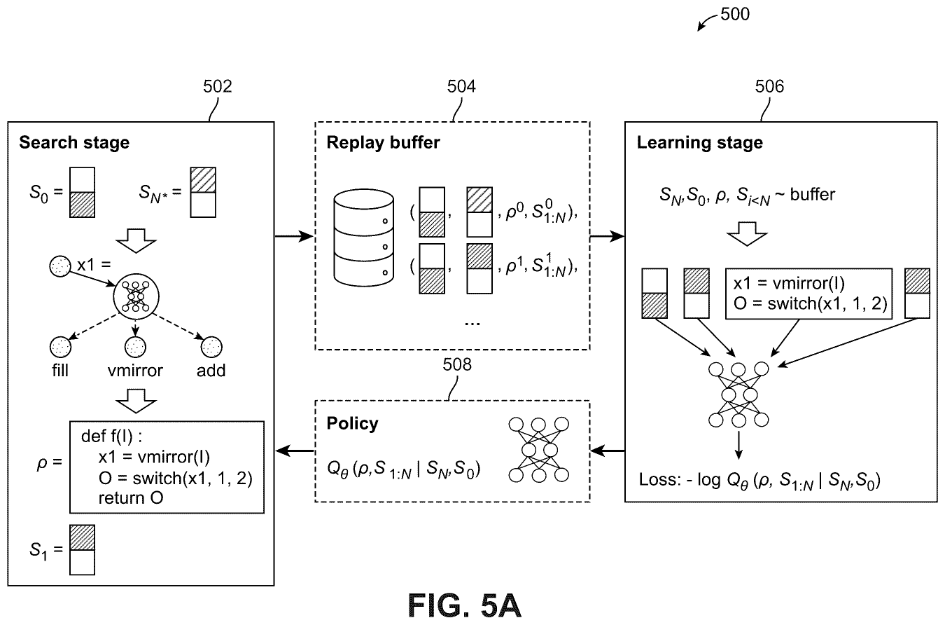

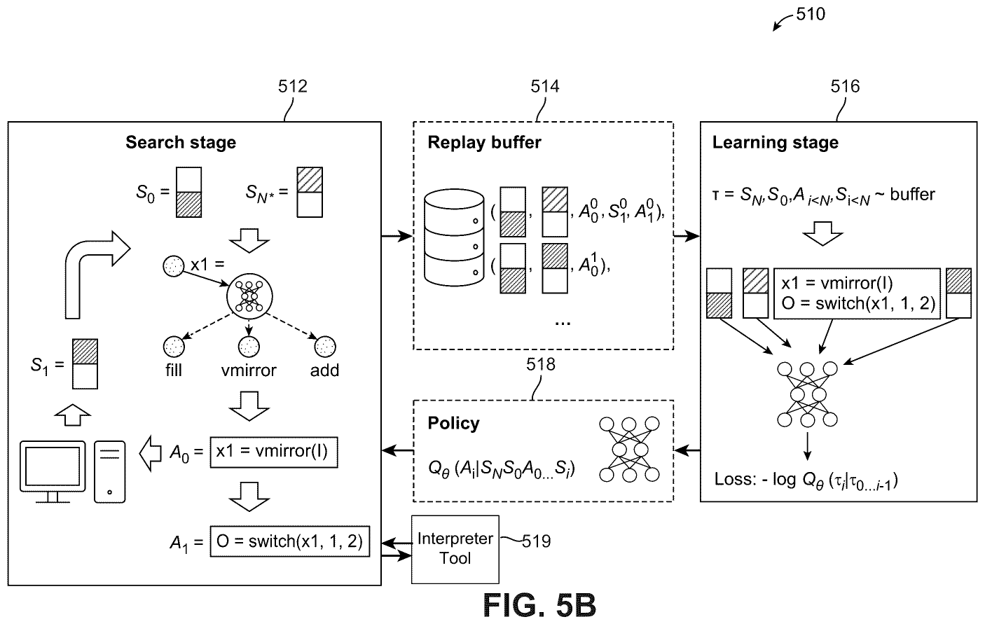

FIG. 5A illustrates a second search and learning system 500 that includes a second search engine 502, a second replay buffer 504, a second learning engine 506 and a second policy 508, which can be one of a transformer-based policy network, a language model, a large language model and/or an encoder-decoder model. The second policy 508 may be a decoder-only model. The second policy 408 can be characterized as an intermediate state policy and can also be a vision-language model that parses grids using convolutional encoders. In the approach which is an extension of the search and learning system 200 of FIG. 2, the concept is to add extra information of intermediate states S₁ from evaluating the variable x1. Note that the intermediate state S₁ can be a state of the sparce grid in between the initial state S₀ and a final state S_{N}*. In some aspects, the second replay buffer 404 can be initialized with training tasks and tasks found from mutating training tasks to prevent overfitting.

FIG. 5B illustrates a third search and learning system 510 that includes a third search engine 512, a third replay buffer 514, a third learning engine 516 and a third policy 518, which can be one of a transformer-based policy network, a language model, a large language model, encoder-decoder model and/or a decoder-only model. The third policy 518 can also be a vision-language model that parses gids using convolutional encoders. In the approach which is an extension of the search and learning system 200 of FIG. 2, the concept is to pass a policy-sampled action Ai to the third search engine 512 and to give the third policy 518 the feedback to sample the next action. The approach can include adding the extra information of the intermediate states S₁ as well to the third replay buffer 514 for training.

In some cases, the search and learning system 200 and/or the other system can use the CodeT5 encoder-decoder transformer. However, this disclosure also encompasses a multi-modal model for the policy 208 that has both vision and language components. The use of such a model may improve performance as the model can process intermediate states such as grids in a different way to text. In some cases, states are embedded using convolutional layers and actions using linear layers. A decoder transformer can be used to predict the next trajectory element conditioned on the embedded representation of previous trajectory elements. The search and learning system 200 and/or other systems can concatenate a pixel representation of the state with a text representation so that every state type is processed in the same way. The search and learning system 200 and/or other systems can then embed the pixel representation with convolutional layers and the text representation with a linear embedding (or text encoder). Further, the trajectory would not include rewards as in a Decision Transformer architecture.

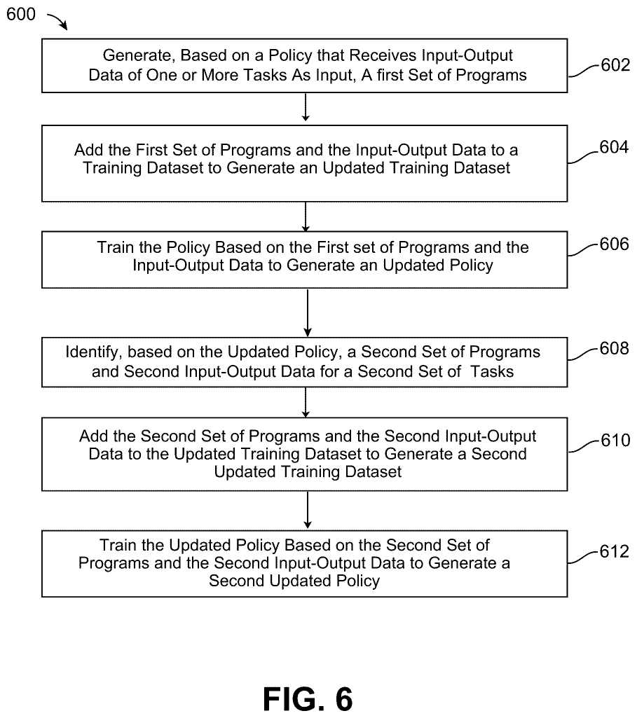

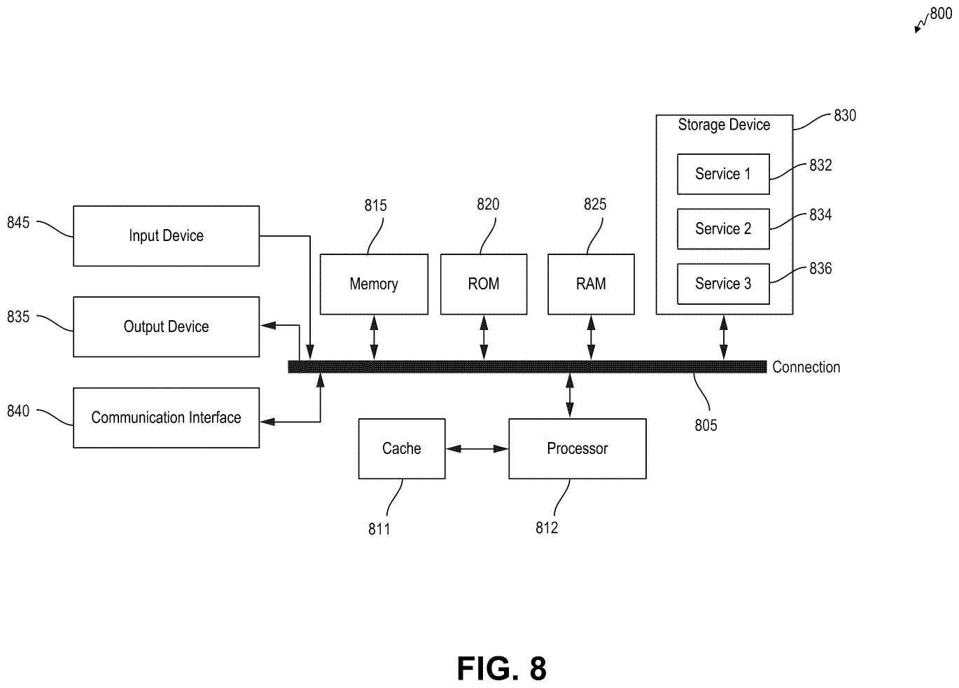

FIG. 6 is a flowchart illustrating an example process 600 for generating a program via an iterative process using one or more of the techniques described herein. In some aspects, the process 600 may be performed by a computing device or apparatus or a component or system (e.g., a chipset, one or more processors (e.g., digital signal processors (DSPs), central processing units (CPUs), neural processing units (NPUs), neural signal processors (NSPs), microprocessors, graphics processing units (GPUs), etc.), a machine learning system such as a neural network model, etc.) of the computing device or apparatus. In some examples, the process 600 can be performed by one or more of the search and learning system 200, the search engine 202, the replay buffer 204, the learning engine 206, the policy 208, the intermediate state search and learning system 400, the second search and learning system 500, the third search and learning system 510 or at least one subsystem thereof, the computing system 800, any combination thereof, and/or other system or component described herein. For instance, a computing device with the computing device architecture of the computing system 800 shown in FIG. 8 can implement the operations of FIG. 6 and/or the components and/or operations described herein with respect to any of FIGS. 2, 3, 4, 5A and/or 5B.

At operation 602, the search and learning system (e.g., the search and learning system 200, the search engine 202, the replay buffer 204. the learning engine 206, the policy 208, the intermediate state search and learning system 400, the second search and learning system 500, the third search and learning system 510 or at least one subsystem thereof, the computing system 800, or a combination thereof) is configured to, and can, generate, based on a policy (e.g., the policy 208) that receives input-output data of one or more tasks as input, a first set of programs.

In some aspects, the program can be associated with a programming language comprising a Domain-Specific Language. The at least one processor can be coupled to the at least one memory and configured to further pre-train the policy on the input-output data and corresponding programs from a dataset such as the abstract reasoning corpus.

In some cases, the policy 208 (or any other policy) can include one of transformer-based policy network, a language model, a large language model, a CodeT5 model, an encoder-only model, a decoder-only model, an encoder-decoder model, or a vision-language model parsing grids using convolutional encoders. In some examples, the policy 208 can process multiple demonstration examples. The first set of programs and the input-output data and the second set of programs and the second input-output data can each have corrected annotated without human intervention.

In some aspects, the processor can add the first set of programs, the input-output data and information associated with an intermediate state (e.g., intermediate variables) to the training dataset stored in the at least one memory to generate an updated training dataset.

In some cases, the first set of programs and the second set of programs are associated with a programming language including a Domain-Specific language (DSL). In another aspect, the first set of programs and the second set of programs can be associated with a programming language designed specifically for an abstract reasoning corpus (ARC) data. In yet another aspect, the first set of programs and the second set of programs can be associated with a programming language that contains basic grid manipulation operators.

In some examples, the programming language can include one or more of a vmirror function which mirrors a grid along a vertical axis and a hmirror function which mirrors the grid along a horizontal axis.

At operation 604, the search and learning system (e.g., the search and learning system 200, the search engine 202, the replay buffer 204. the learning engine 206, the policy 208, the intermediate state search and learning system 400, the second search and learning system 500, the third search and learning system 510 or at least one subsystem thereof, the computing system 800, or a combination thereof) is configured to, and can, add the first set of programs and the input-output data to a training dataset to generate an updated training dataset.

At operation 606, the search and learning system (e.g., the search and learning system 200, the search engine 202, the replay buffer 204. the learning engine 206, the policy 208, the intermediate state search and learning system 400, the second search and learning system 500, the third search and learning system 510 or at least one subsystem thereof, the computing system 800, or a combination thereof) is configured to, and can, train the policy 208 based on the first set of programs and the input-output data to generate an updated policy.

In another aspect, the at least one processor can be coupled to the at least one memory and configured to train the policy 208 based on the first set of programs and the input-output data to generate the updated policy based on an intermediate state generated from evaluating a variable, a program or a partial program.

In another aspect, the at least one processor can be coupled to the at least one memory and configured to train the policy based on the first set of programs and the input-output data to generate the updated policy based on a policy-sampled action. In yet another aspect, the at least one processor can be coupled to the at least one memory and configured to train the policy 208 based on the first set of programs and the input-output data to generate the updated policy based on the policy-sampled action and an intermediate state.

At operation 606, the search and learning system (e.g., the search and learning system 200, the search engine 202, the replay buffer 204. the learning engine 206, the policy 208, the intermediate state search and learning system 400, the second search and learning system 500, the third search and learning system 510 or at least one subsystem thereof, the computing system 800, or a combination thereof) is configured to, and can, train the policy based on the first set of programs and the input-output data to generate an updated policy.

At operation 608, the search and learning system (e.g., the search and learning system 200, the search engine 202, the replay buffer 204. the learning engine 206, the policy 208, the intermediate state search and learning system 400, the second search and learning system 500, the third search and learning system 510 or at least one subsystem thereof, the computing system 800, or a combination thereof) is configured to, and can, identify, based on the updated policy, a second set of programs for second input-output data for a second set of tasks.

At operation 610, the search and learning system (e.g., the search and learning system 200, the search engine 202, the replay buffer 204. the learning engine 206, the policy 208, the intermediate state search and learning system 400, the second search and learning system 500, the third search and learning system 510 or at least one subsystem thereof, the computing system 800, or a combination thereof) is configured to, and can, add the second set of programs and second input-output data to the updated training dataset to generate a second updated training dataset.

At operation 612, the search and learning system (e.g., the search and learning system 200, the search engine 202, the replay buffer 204. the learning engine 206, the policy 208, the intermediate state search and learning system 400, the second search and learning system 500, the third search and learning system 510 or at least one subsystem thereof, the computing system 800, or a combination thereof) is configured to, and can, train the updated policy based on the second set of programs and the second input-output data to generate a second updated policy. One iteration is described in FIG. 6. The process 600 can includes further iterations as well.

In some aspects, the at least one processor can be coupled to the at least one memory and configured to add the first program, the first input-output data, and the intermediate state (such as intermediate variables) to the training dataset stored in the at least one memory to generate the updated training dataset.

In some cases, the at least one processor can be coupled to the at least one memory and configured to add the first set of programs, the input-output data, the intermediate state and the policy-sampled action to the training dataset stored in the at least one memory to generate the updated training dataset.

In some aspects, a non-transitory computer-readable medium having stored thereon instructions which, when executed by at least one processor, cause the at least one processor to perform operations according to any of operations 602-612. In another example, an apparatus can include one or more means for performing operations according to any of operations 602-612.

In some examples, the foundational model system includes: means for encoding the input data to generate encoded representations of the input data; means for identifying a first program and first input-output data for a first given task and based on a policy; means for adding the first set of programs and the input-output data to a training dataset to generate an updated training dataset; means for training the policy based on the first set of programs and the input-output data to generate an updated policy; means for identifying, based on the updated policy, a second set of programs for second input-output data for a second set of tasks; means for adding the second set of programs and second input-output data to the updated training dataset to generate a second updated training dataset; and means for training the updated policy based on the second set of programs and the second input-output data to generate a second updated policy.

The means for performing these operations can include, for instance, any one or more of the search and learning system 200, the intermediate state search and learning system 400, the second search and learning system 500, the third search and learning system 510 or at least one subsystem thereof). A computing device with the computing device architecture of the computing system 800 shown in FIG. 8 can implement the operations of FIG. 6 and/or the components and/or operations described herein with respect to any of FIGS. 2, 4A, 4B and/or 6.

In some examples, the processes described herein (e.g., process 600 and/or any other process described herein) may be performed by a computing device or apparatus. The computing device can include any suitable device, such as a mobile device (e.g., a mobile phone), a desktop computing device, a tablet computing device, an XR device (e.g., a VR headset, an AR headset, AR glasses, etc.), a wearable device (e.g., a network-connected watch or smartwatch, or other wearable device), a server computer, a vehicle (e.g., an autonomous vehicle) or computing device of the vehicle, a robotic device, a laptop computer, a smart television, a camera, a robot having various configurations and capabilities, and/or any other computing device with the resource capabilities to perform the processes described herein, including the process 600 and/or any other process described herein. In some cases, the computing device or apparatus may include various components, such as one or more input devices, one or more output devices, at least one processor, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), neural processing units (NPUs), neural signal processors (NSPs), and/or other suitable electronic circuits), and/or can include and/or be implemented using computer software, firmware, or any combination thereof, to perform the various operations described herein.

The process 600 is illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by at least one processor, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 600 and/or any other process described herein may be performed under the control of one or more computer systems configured with executable instructions and may be implemented as code (e.g., executable instructions, one or more computer programs, or one or more applications) executing collectively on at least one processor, by hardware, or combinations thereof. As noted above, the code may be stored on a computer-readable or machine-readable storage medium, for example, in the form of a computer program comprising a plurality of instructions executable by at least one processor. The computer-readable or machine-readable storage medium may be non-transitory.

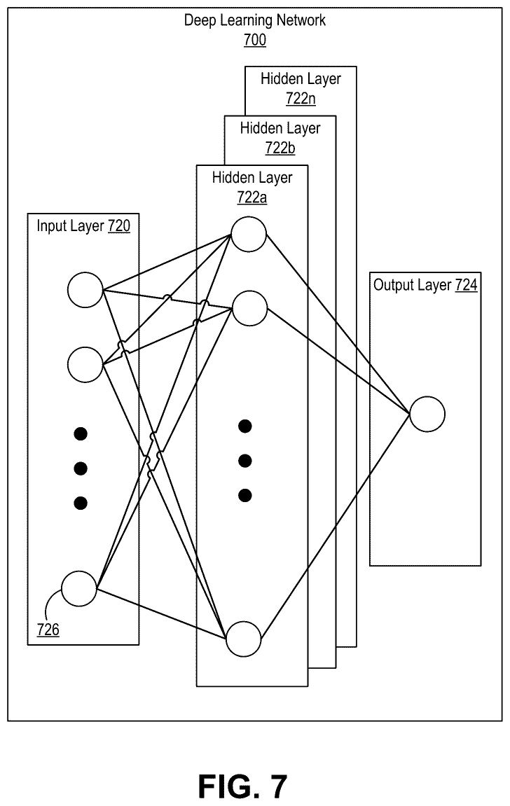

As described herein, the neural network 700 of FIG. 7 may be implemented using a neural network, multiple neural networks or a deep-learning neural network. An input layer 720 includes input data. In some examples, the input layer 720 can include data representing the pixels of an input video frame. The neural network 700 includes multiple hidden layers 722a, 722b, through 722n. The multiple hidden layers 722a, 722b, through 722n include “n” number of hidden layers, where “n” is an integer greater than or equal to one. The number of hidden layers can be made to include as many layers as needed for the given application. The neural network 700 further includes an output layer 724 that provides an output resulting from the processing performed by the multiple hidden layers 722a, 722b, through 722n. In some examples, the output layer 724 can provide a classification for an object in an input video frame. The classification can include a class identifying the type of object (e.g., a person, a dog, a cat, or other object).

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the multiple hidden layers 722a, 722b, through 722n can transform the information of each input node by applying activation functions to the information. The information derived from the transformation can then be passed to and can activate the nodes of the next hidden layer 722b, which can perform their own designated functions. Example functions include convolutional, up-sampling, data transformation, and/or any other suitable functions. The output of the next hidden layer 722b can then activate nodes of the next hidden layer, and so on. The output of the last hidden layer 722n can activate one or more nodes of the output layer 724, at which an output is provided. In some cases, while nodes (e.g., node 726) in the neural network 700 are shown as having multiple output lines, a node has a single output and all lines shown as being output from a node represent the same output value.

In some cases, each node or interconnection between nodes can have a weight that is a set of parameters derived from the training of the neural network 700. Once the neural network 700 is trained, the neural network 700 can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different multiple hidden layers 722a, 722b, through 722n in order to provide the output through the output layer 724. In an example in which the neural network 700 is used to identify objects in images, the neural network 700 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 700 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 700 is trained well enough so that the weights of the layers are accurately tuned.

For the example of identifying objects in images, the forward pass can include passing a training image through the neural network 700. The weights are initially randomized before the neural network 700 is trained. The image can include, for example, an array of numbers representing the pixels of the image. Each number in the array can include a value from 0 to 255 describing the pixel intensity at that position in the array. In some examples, the array can include a 28×28×3 array of numbers with 28 rows and 28 columns of pixels and 3 color components (such as red, green, and blue, or luma and two chroma components, or the like).

For a first training iteration for the neural network 700, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 700 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times a ground truth output (e.g., the actual answer) minus the predicted output (e.g., the predicted answer) squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 700 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

In some cases, the neural network 700 can be trained using self-supervised learning.

The neural network 700 can include any suitable deep network. One example includes a convolutional neural network (CNN), which includes an input layer and an output layer, with multiple hidden layers between the input and out layers. An example of a CNN is described below with respect to FIG. 7. The hidden layers of a CNN include a series of convolutional, nonlinear, pooling (for downsampling), and fully connected layers. The neural network 700 can include any other deep network other than a CNN, such as an autoencoder, a deep belief nets (DBNs), a Recurrent Neural Networks (RNNs), among others.

FIG. 8 is a diagram illustrating an example of a system for implementing certain aspects of the present disclosure. In particular, FIG. 8 illustrates an example of computing system 800, which can be for example any computing device making up a computing system, a camera system, or any component thereof in which the components of the system are in communication with each other using connection 805. Connection 805 can be a physical connection using a bus, or a direct connection into processor 812, such as in a chipset architecture. Connection 805 can also be a virtual connection, networked connection, or logical connection.

In some examples, computing system 800 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example computing system 800 includes at least one processing unit (CPU or processor) 810 and connection 805 that couples various system components including system memory 815, such as read-only memory (ROM) 820 and random access memory (RAM) 825 to processor 812.

Computing system 800 can include a cache 811 of high-speed memory connected directly with, in close proximity to, or integrated as part of processor 812.

Processor 812 can include any general purpose processor and a hardware service or software service, such as services 832, 834, and 836 stored in storage device 830, configured to control processor 812 as well as a special-purpose processor where software instructions are incorporated into the actual processor design. Processor 812 may essentially be a completely self-contained computing system, containing multiple cores or processors, a bus, memory controller, cache, etc. A multi-core processor may be symmetric or asymmetric.

To enable user interaction, the computing system 800 includes an input device 845, which can represent any number of input mechanisms, such as a microphone for speech, a touch-sensitive screen for gesture or graphical input, keyboard, mouse, motion input, speech, etc. The computing system 800 can also include output device 835, which can be one or more of a number of output mechanisms. In some instances, multimodal systems can enable a user to provide multiple types of input/output to communicate with the computing system 800. The computing system 800 can include communications interface 840, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 812, it causes the system to perform a function. In some examples, a hardware service that performs a particular function can include the software component stored in a computer-readable medium in connection with the necessary hardware components, such as processor 812, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate the interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include at least one processor, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus to generate a program in an iterative process, comprising: at least one memory; and at least one processor coupled to the at least one memory and configured to: generate, based on a policy that receives input-output data of one or more tasks as input, a first set of programs; add the first set of programs and the input-output data to a training dataset to generate an updated training dataset; train the policy based on the first set of programs and the input-output data to generate an updated policy; identify, based on the updated policy, a second set of programs for second input-output data for a second set of tasks; add the second set of programs and second input-output data to the updated training dataset to generate a second updated training dataset; and train the updated policy based on the second set of programs and the second input-output data to generate a second updated policy.

Aspect 2. The apparatus of Aspect 1, wherein the program is associated with a programming language comprising a Domain-Specific Language (DSL).

Aspect 3. The apparatus of any of Aspects 1-2, wherein the at least one processor is configured to pre-train the policy on the input-output data and corresponding programs from a dataset.

Aspect 4. The apparatus of any of Aspects 1-3, wherein the dataset comprises an abstract reasoning corpus.

Aspect 5. The apparatus of any of Aspects 1-4, wherein the policy comprises one of transformer-based policy network, a language model, a large language model, a CodeT5 model, an encoder-only model, a decoder-only model, an encoder-decoder model, or a vision-language model parsing grids using convolutional encoders.

Aspect 6. The apparatus of any of Aspects 1-5, wherein the policy processes multiple demonstration examples.

Aspect 7. The apparatus of any of Aspects 1-6, wherein the first set of programs and the input-output data and the second set of programs and the second input-output data are each corrected or annotated without human intervention.

Aspect 8. The apparatus of any of Aspects 1-7, wherein the at least one processor is configured to add the first set of programs, the input-output data, and information associated with an intermediate state to the training dataset stored in the at least one memory to generate an updated training dataset.

Aspect 9. The apparatus of any of Aspects 1-8, wherein the first set of programs and the second set of programs are associated with a programming language comprising domain-specific language (DSL).

Aspect 10. The apparatus of any of Aspects 1-9, wherein the first set of programs and the second set of programs are associated with a programming language designed specifically for an abstract reasoning corpus (ARC) dataset.

Aspect 11. The apparatus of any of Aspects 1-10, wherein the first set of programs and the second set of programs are associated with a programming language that contains basic grid manipulation operators.

Aspect 12. The apparatus of any of Aspects 1-11, wherein the programming language comprises one or more of a vertical mirror function configured to mirror a grid along a vertical axis and a horizontal mirror function configured to mirror the grid along a horizontal axis.

Aspect 13. The apparatus of any of Aspects 1-12, wherein the at least one processor is configured to train the policy based on the first set of programs and the input-output data to generate the updated policy based on an intermediate state generated from evaluating a program or partial program.

Aspect 14. The apparatus of any of Aspects 1-13, wherein the at least one processor is configured to train the policy based on the first set of programs and the input-output data to generate the updated policy based on a policy-sampled action.

Aspect 15. The apparatus of any of Aspects 1-14, wherein the at least one processor is configured to train the policy based on the first set of programs and the input-output data to generate the updated policy based on the policy-sampled action and an intermediate state.

Aspect 16. The apparatus of any of Aspects 1-15, wherein the at least one processor is configured to add the first set of programs, the input-output data, and the intermediate state to the training dataset stored in the at least one memory to generate the updated training dataset.

Aspect 17. The apparatus of any of Aspects 1-16, wherein the at least one processor is configured to add the first set of programs, the input-output data, the intermediate state and the policy-sampled action to the training dataset stored in the at least one memory to generate the updated training dataset.

Aspect 18. A method of generating a program in an iterative process, the method comprising: generating, based on a policy that receives input-output data of one or more tasks as inputs, a first set of programs; adding the first set of programs and the input-output data to a training dataset to generate an updated training dataset; training the policy based on the first set of programs and the input-output data to generate an updated policy; identifying a second set of programs for second input-output data for a second set of tasks and based on the updated policy; adding the second set of programs and second input-output data to the updated training dataset to generate a second updated training dataset; and training the updated policy based on the second set of programs and the second input-output data to generate a second updated policy.

Aspect 19. The method of Aspect 18, wherein the program is associated with a programming language comprising a Domain-Specific Language (DSL).

Aspect 20. The method of any of Aspects 18-19, wherein the at least one processor is configured to pre-train the policy on the input-output data and corresponding programs from a dataset.

Aspect 21. The method of any of Aspects 18-20, wherein the dataset comprises an abstract reasoning corpus.

Aspect 22. The method of any of Aspects 18-21, wherein the policy comprises one of transformer-based policy network, a language model, a large language model, a CodeT5 model, an encoder-only model, a decoder-only model, an encoder-decoder model, or a vision-language model parsing grids using convolutional encoders.

Aspect 23. The method of any of Aspects 18-22, wherein the policy processes multiple demonstration examples.

Aspect 24. The method of any of Aspects 18-23, wherein the first set of programs and the input-output data and the second set of programs and the second input-output data are each corrected or annotated without human intervention.

Aspect 25. The method of any of Aspects 18-24, wherein the at least one processor is configured to add the first set of programs, the input-output data, and information associated with an intermediate state to the training dataset stored in the at least one memory to generate an updated training dataset.

Aspect 26. The method of any of Aspects 18-25, wherein the first set of programs and the second set of programs are associated with a programming language comprising domain-specific language (DSL).

Aspect 27. The method of any of Aspects 18-26, wherein the first set of programs and the second set of programs are associated with a programming language designed specifically for an abstract reasoning corpus (ARC) dataset.

Aspect 28. The method of any of Aspects 18-27, wherein the first set of programs and the second set of programs are associated with a programming language that contains basic grid manipulation operators.

Aspect 29. The method of any of Aspects 18-28, wherein the programming language comprises one or more of a vertical mirror function configured to mirror a grid along a vertical axis and a horizontal mirror function configured to mirror the grid along a horizontal axis.

Aspect 30. The method of any of Aspects 18-29, wherein the at least one processor is configured to train the policy based on the first set of programs and the input-output data to generate the updated policy based on an intermediate state generated from evaluating a program or partial program.

Aspect 31. The method of any of Aspects 18-30, wherein the at least one processor is configured to train the policy based on the first set of programs and the input-output data to generate the updated policy based on a policy-sampled action.

Aspect 32. The method of any of Aspects 18-31, wherein the at least one processor is configured to train the policy based on the first set of programs and the input-output data to generate the updated policy based on the policy-sampled action and an intermediate state.

Aspect 33. The method of any of Aspects 18-32, wherein the at least one processor is configured to add the first set of programs, the input-output data, and the intermediate state to the training dataset stored in the at least one memory to generate the updated training dataset.

Aspect 34. The method of any of Aspects 18-33, wherein the at least one processor is configured to add the first set of programs, the input-output data, the intermediate state and the policy-sampled action to the training dataset stored in the at least one memory to generate the updated training dataset.

Aspect 35. An apparatus for generating a program in an iterative process, the apparatus comprising: means for generating, based on a policy that receives input-output data of one or more tasks as inputs, a first set of programs; means for adding the first set of programs and the input-output data to a training dataset to generate an updated training dataset; means for training the policy based on the first set of programs and the input-output data to generate an updated policy; means for identifying a second set of programs for second input-output data for a second set of tasks and based on the updated policy; means for adding the second set of programs and second input-output data to the updated training dataset to generate a second updated training dataset; and means for training the updated policy based on the second set of programs and the second input-output data to generate a second updated policy.

Aspect 36. A computer-readable storage medium storing instructions which, when executed by at least one processor, cause the at least one processor to be configured to: generate, based on a policy that receives input-output data of one or more tasks as input, a first set of programs; add the first set of programs and the input-output data to the training dataset to generate an updated training dataset; train the policy based on the first set of programs and the input-output data to generate an updated policy; identify, based on the updated policy, a second set of programs for second input-output data for a second set of tasks; add the second set of programs and second input-output data to the updated training dataset to generate a second updated training dataset; and train the updated policy based on the second set of programs and the second input-output data to generate a second updated policy.

Aspect 37. A non-transitory computer-readable medium having stored thereon instructions which, when executed by at least one processor, cause the at least one processor to perform operations according to any of Aspects 18-34.

Aspect 38. An apparatus comprising means for performing operations according to any of Aspects 18-34.

What is claimed is:

1. An apparatus to generate a program in an iterative process, comprising:
at least one memory; and
at least one processor coupled to the at least one memory and configured to:
generate, based on a policy that receives input-output data of one or more tasks as input, a first set of programs;
add the first set of programs and the input-output data to a training dataset to generate an updated training dataset;
train the policy based on the first set of programs and the input-output data to generate an updated policy;
identify, based on the updated policy, a second set of programs for second input-output data for a second set of tasks;
add the second set of programs and second input-output data to the updated training dataset to generate a second updated training dataset; and
train the updated policy based on the second set of programs and the second input-output data to generate a second updated policy.

2. The apparatus of claim 1, wherein the at least one processor is configured to pre-train the policy on the input-output data and corresponding programs from a dataset.

3. The apparatus of claim 1, wherein the policy comprises one of transformer-based policy network, a language model, a large language model, a CodeT5 model, a decoder-only model, an encoder-decoder model, or a vision-language model parsing grids using convolutional encoders.

4. The apparatus of claim 1, wherein the first set of programs and the input-output data and the second set of programs and the second input-output data are each corrected or annotated without human intervention.

5. The apparatus of claim 1, wherein the at least one processor is configured to add the first set of programs, the input-output data, and information associated with an intermediate state to the training dataset stored in the at least one memory to generate an updated training dataset.

6. The apparatus of claim 1, wherein the at least one processor is configured to train the policy based on the first set of programs and the input-output data to generate the updated policy based on an intermediate state generated from evaluating a program or partial program.

7. The apparatus of claim 1, wherein the at least one processor is configured to train the policy based on the first set of programs and the input-output data to generate the updated policy based on a policy-sampled action.

8. The apparatus of claim 7, wherein the at least one processor is configured to train the policy based on the first set of programs and the input-output data to generate the updated policy based on the policy-sampled action and an intermediate state.

9. The apparatus of claim 8, wherein the at least one processor is configured to add the first set of programs, the input-output data, and the intermediate state to the training dataset stored in the at least one memory to generate an updated training dataset.

10. The apparatus of claim 8, wherein the at least one processor is configured to add the first set of programs, the input-output data, the intermediate state, and the policy-sampled action to the training dataset stored in the at least one memory to generate the updated training dataset.

11. A method of generating a program in an iterative process, the method comprising:
generating, based on a policy that receives input-output data of one or more tasks as inputs, a first set of programs;
adding the first set of programs and the input-output data to a training dataset to generate an updated training dataset;
training the policy based on the first set of programs and the input-output data to generate an updated policy;
identifying a second set of programs for second input-output data for a second set of tasks and based on the updated policy;
adding the second set of programs and second input-output data to the updated training dataset to generate a second updated training dataset; and
training the updated policy based on the second set of programs and the second input-output data to generate a second updated policy.

12. The method of claim 11, further comprising pre-training the policy on the input-output data and corresponding programs from a dataset.

13. The method of claim 11, wherein the policy comprises one of transformer-based policy network, a language model, a large language model, a CodeT5 model, an encoder-only model, a decoder-only model, an encoder-decoder model, or a vision-language model parsing grids using convolutional encoders.

14. The method of claim 11, wherein the first set of programs and the input-output data and the second set of programs and the second input-output data are each corrected or annotated without human intervention.

15. The method of claim 11, further comprising adding the first set of programs, the input-output data, and information associated with an intermediate state to the training dataset to generate an updated training dataset.

16. The method of claim 11, further comprising training the policy based on the first set of programs and the input-output data to generate the updated policy based on an intermediate state generated from evaluating a program or partial program.

17. The method of claim 16, further comprising adding the first set of programs, the input-output data, and the intermediate state to the training dataset to generate an updated training dataset.

18. The method of claim 11, further comprising training the policy based on the first set of programs and the input-output data to generate the updated policy based on a policy-sampled action.

19. The method of claim 18, further comprising training the policy based on the first set of programs and the input-output data to generate the updated policy based on the policy-sampled action and an intermediate state.
